(19) United States
(12) Patent Application Publication
(10) Pub. No.: US 2004/0043354 A1
(43) Pub. Date: Mar. 4, 2004

(54) Dental articulator with multiple methods to support the dental models

(76) Inventor: Hsien-Tzu Chou, North Plainfield, NJ (US)

Correspondence Address: Hsien-Tzu Chou, Apt. 49, 1165 Route 22 West, North Plainfield, NJ, 07060, US

(21) Appl. No.: 10/228,818

(22) Filed: Aug. 27, 2002

(51) Int. Cl. A61C 11/00

(52) U.S. Cl. 433/60; 433/64

(57) ABSTRACT

A dental articulator apparatus has an upper jaw member and a lower jaw member and the upper jaw member pivotally mount to the lower jaw member. Both upper and lower jaw members have a male projection part and a disposable-mounting arm for each member. The disposable-mounting arm is formed with a female receiving aperture sized to releasably mount within either of the male projection part of the upper and lower jaw members. Each male projection part has positional stops means engaging with recesses on the female receiving aperture for insuring that the disposable-mounting arms are always accurately located in the same unchanging position on the upper and lower jaw members. The disposable-mounting arms have different designs to accommodate different mediums for mounting the dental models to the disposable-mounting arms. The disposable-mounting arm with an oval-shaped bar design is for using plaster of paris. The disposable-mounting arm with a ball-shaped design is for using adhesives. The disposable-mounting arm with a U-shaped tray design is for directly embedding the dental model into the tray. The upper and lower jaw members are made from metal having sufficient rigidity so that an accurate bite relationship between the upper and lower dental models can be repetitively reproduced. The disposable-mounting arms are made from inexpensive plastic to allow disposal after use.

### FIELD OF INVENTION

The present invention relates to dental articulator and more particularly this invention relates to an improved dental articulator which is a reusable dental articulator system having multiple methods to support the dental models by using the different designs of the disposable-mounting arms.

### BACKGROUND OF INVENTION

Dental articulators are used by dentists and dental technicians to make dental prosthesis like a denture, crown, bridge, cap, laminate, inlay or an onlay, etc. A dental articulator simulates the movement of the human jaw and most often include an upper jaw member spaced opposite a lower jaw member, these members connected to each other for relative hinging and sliding movement. Upper and lower dental models are mounted to the upper and lower jaw members respectively so that the dental models are held in relative alignment to allow precise dental measurements and relationships to be determined during the fabrication of the relevant dental prosthesis. In general, dental articulators assist the dentists and dental technicians in preparing an accurately fitting dental prosthesis for patients.

Dental articulators range from very simple to very complex devices. The primary difference among them is in the number of controls or adjustments they possess. Based on the adjustability factor, articulators fall into three broad categories: nonadjustable, semiadjustable, and fully adjustable. Nonadjustable articulators, such as the hinge type articulators shown in U.S. Pat. No. 530,524 to Hitch in 1894 and U.S. Pat. No. 3,221,408 to Scullin in 1961 or fixed-guide type articulators disclosed in U.S. Pat. No. 1,517,922 to Stanley in 1921 and U.S. Pat. No. 2,617,195 to Perkell in 1950, are intended for making simple fixed and removable prostheses, such as crowns, bridges and some partial dentures. Semiadjustable articulators such as in U.S. Pat. No. 2,748,481 to Glueck in 1954 and U.S. Pat. No. 4,024,640 to Guichet in 1977 are intended for making all forms of removable prostheses and for moderately complicated fixed prosthodontic replacements. Fully adjustable articulators such as shown in U.S. Pat. No. 2,119,896 to Van Dorn and Terrell in 1935 and U.S. Pat. No. 3,908,271 to Derda and Gibbs in 1975 are intended for treating patients whose jaw movement patterns are not normal and for making complete fixed prosthodontic restorations.

Semiadjustable articulators and fully adjustable articulators possess a number of adjustments and controls, which increased the cost and the complexity of operating these devices as compared to nonadjustable type. The extensive training is required to properly operate and obtain the benefits offered by these devices. As a result, these devices have not received wide spread use among dentists and by dental laboratories.

Nonadjustable articulators include the fixed-guide type articulators that are machined to produce the lateral and protrusive movements that are characteristic of a statistically average patient. As a result, in practice, most dentists and dental laboratories use nonadjustable articulators especially fixed-guide type articulators to make most of the fixed and removable dental prostheses, including full dentures and fixed prosthodontic replacements.

Based on the material used to construct the articulators, we can categorize articulators to reusable articulators and one-use disposable articulators. The reusable articulators such as in U.S. Pat. No. 2,617,195 and U.S. Pat. No. 4,024,640 are made from metal having sufficient rigidity too accurate repeat the bite relationship. The one-use disposable articulators disclosed in U.S. Pat. No. 6,247,927 to Walter in 2001, U.S. Pat. No. 5,658,143 to Kuperman in 1997 and U.S. Pat. No. 4,382,787 to Huffman in 1983 currently available are constructed from flexible, plastic materials and lack the rigidity required to repetitively reproducing an accurate bite relationship during use. Fully adjustable articulators and semiadjustable articulators are all metal reusable articulators. Nonadjustable articulators are either metal reusable articulators or plastic one-use disposable articulators.

Upper and lower dental models have to mount to the upper and lower jaw members of the articulator. In general, there are four different ways to support the dental models to an articulator, which are using plaster of paris, adhesive, clamp or tray. The reusable articulators are usually using plaster of paris or clamp to support the dental models to the articulators. For example, the articulators in U.S. Pat. No. 1,517,922 and U.S. Pat. No. 2,617,195 use plaster of paris to mount the dental models to the articulators and the articulators shown in U.S. Pat. No. 981,430 to Kennedy in 1911 and U.S. Pat. No. 5,015,182 to Newberry in 1991 use clamps to secure the dental models to the articulators. The one-use disposable articulators are usually using adhesive to mount the dental models to the articulators such as shown in U.S. Pat. No. 4,382,787.

Using adhesive or clamp is much fast and easy compared to the plaster of pairs. While there are a wide variety of shapes, sizes and arrangement of human jaws and teeth, configurations and occlusion pattern have a broad range among different patients. The advantage of using plaster of paris is it can be manipulated to accurately set the dental models on the articulator, so the occlusal plane is parallel to the upper and lower jaw members and the midline is in the center of the articulator. It is difficult to achieve this kind of precise position by using adhesive or clamp. But the disadvantage of using plaster of paris is time consuming because it requires considerable time in the processes of mixing, placing, curing, clean-up and then the subsequent removal of the hardened plaster from the models and articulator after completion of the prosthesis so as to allow re-use of the articulator.

Using tray system that has already connected to the articulator is another way to support the dental models to the articulator such as shown in U.S. Pat. No. 6,247,927 and U.S. Pat. No. 5,658,143. The dental models are embedded into the trays while dental models are still in unhardened stage. When the dental models cure, they are mounted to the trays and subsequently they are connected to the articulator. The disadvantage of using tray system articulator is that the dental models will be difficult to accurately position in the articulator to achieve the occlusal plane parallel to the upper and lower jaw members and the midline in the center of the articulator.

There are so many different types of articulators have been commercially available in the market. The dentists have their preference for the articulator. A lot of the dentists don't like the one-use disposable articulators made from the plastic because such articulators are not as stiff and rigid as could be desired thus the bite registration change with even modest flexing and twisting. But some dentists can accept the articulators made form plastic. Many dental laboratories like to use adhesive to mount the dental models to the articulators because it saves time, material and money. But most of the dentists prefer to use plaster of paris to mount the dental models because it is more accuracy and strong, and it also has more presentational value. After the dental prosthesis is done, the dentists would like to receive the dental models with the articulator in order to check the prosthesis is properly done or not. But the dental laboratories prefer to send the dental models without the articulators in order to save money.

In practice, dental laboratories must prepare all different kind of the articulators to fulfill different dentists' requirements. As a result, dental laboratories have to stock up all different kind of the articulators and they take a lot of space and cost a lot of money. So there exist a need for dental models could be removable, retractable and realignable upon an articulator so that the dentists and dental technicians are able to check and work freely on their own articulator. Furthermore, a need also exist for a versatile dental articulator to have multiple methods to support the dental models to the articulator so that the dental laboratories can only carry one articulator system and still satisfy every dentists' requirements.

### DESCRIPTION OF THE PRIOR ART

Accordingly, many dental articulators have been developed to permit removable attachment of dental models to a dental articulator and thus the use of one such articulator with a number of different dental models. Various articulators are shown in U.S. Pat. No. 4,024,640, U.S. Pat. No. 2,748,481 and U.S. Pat. No. 3,123,914 to De Pietro in 1962. These articulators have mounting ring that supports a dental model on each of the jaw member, and which mounting ring is removably attachable to the respective from jaw member by use of a threaded fastener. The mounting ring used is generally a flat disc-like member having a threaded hold to receive the threaded portion of mounting screw which extends through the jaw member to secure the mounting ring. In spite of the advances represented by these various prior art system there remains a need for improvements beyond the conventional mounting ring and screw arrangement represented therein.

Other prior art articulator approaches to the problem utilizing a disposable mounting plate to secure the dental model. For example, in U.S. Pat. No. 4,451,234 to Oye in 1984 disclosed the dental model is mounted to the mounting plate by plaster of paris and in U.S. Pat. No. 5,720,613 to Zuckerman in 1998 which the dental model is mounted to the mounting plate by adhesive. These dental articulators can only use one media such as plaster of paris or adhesive to mount the dental model to the mounting plate and the articulators also lack of lateral and protrusive movement simulated the human jaws. So there remains a need for an articulator that has multiple methods to support the dental model to the articulator.

From the disposable mounting plate to the more recent trend of using disposable or dispensable one-use articulators such those shown in U.S. Pat. No. 6,247,927, U.S. Pat. No. 5,658,143 and U.S. Pat. No. 4,382,787, a primary shortcoming found in all of these and all prior art one-use articulators is the plastic material that lack of sufficiently firm to reproduce the bite relationship during use and the accuracy of the prosthetic work is jeopardized. The one-use articulators are also unable to properly allow for lateral and protrusive motions between the articulated models. Another disadvantage of one-use articulator is when the dental models needed to rearticulate for one-use articulator that the old articulator must be cut away and a new articulator must be used.

The prior art includes numerous articulators for supporting upper and lower dental models. While these articulators may be suitable for the particular purpose to which they address, they would not have the versatility of present invention especially with respect to multiple methods to support the dental models.

### OBJECTS OF THE INVENTION

It is therefore an object of the present invention to provide a new and improved reusable dental articulator system and method may be used in the fabrication of various types of dental prostheses.

It is another object of the present invention to provide a new and improved reusable dental articulator system which are machined to produce the lateral and protrusive movement which will simulate the complex movement of human jaw.

It is yet another object of the present invention to provide a new and improved reusable dental articulator system where in the upper and lower jaw members, the posts support for members and hinges are constructed by metal materials and therefor achieve the stable or sturdy construction for such dental articulator that can accurate repeat the bite relationship.

It is a further object of the present invention to provide a new and improved connection of dental articulator to disposable-mounting arms consisting of upper and lower jaw members each having a male projection part that lock into a female receiving aperture in the disposable-mounting arms.

It is yet a further object of the present invention to provide a new and improved connection of dental articulator to disposable-mounting arms whereby either disposable-mounting arm with female receiving aperture can be interchangeably locked into male projection part of the upper and lower jaw members.

It is still a further object of the present invention to provide a new and improved connection of dental articulator to disposable-mounting arms whereby each disposable-mounting arm may be easily released and slipped out of male projection part in the dental articulator.

Another object of present invention is to provide different designs of the disposable-mounting arms, to which the dental model can be mounted with different mediums such as plaster of paris, an adhesive or a tray.

Yet another object of present invention is to provide a disposable-mounting arm with an oval-shaped design to mount the dental model by plaster of paris.

Still another object of present invention is to provide a disposable-mounting arm with a ball-shaped design to obtain the multiple angles for mounting the dental model by adhesive.

Yet still another object of present invention is to provide a disposable-mounting arm with a U-shaped tray design to embed the dental model in the tray.

A further object of the present invention is to provide a new and improved reusable dental articulator system that incorporated the disposable-mounting arms, which are economical plastic construction and allow to disposal after use.

Yet a further object of the present invention is to provide a new and improved reusable dental articulator system in which proper alignment of the dental model upon the articulator is maintained after repeated disconnections and reconnections.

Still a further object of the present invention is to provide a new and improved reusable dental articulator system that is simple in operation and yet extremely precise in its function and applicability to dental prostheses.

It is yet another object of the present invention to provide the disposable-mounting arms not to be reused and which are left the dental models in place to be sent to the dentist so it is unnecessary to mail or sent the articulator with the dental models since the disposable-mounting arms remain as a permanent part of the models and may be inserted in another articulator of the same type.

It is still another object of the present invention to provide a new and improved reusable dental articulator system for dental laboratories to use one articulator system and still able to satisfy all different dentists' requirement.

The present invention aims to overcome the disadvantage of the prior art.

### SUMMARY OF THE INVENTION

The above objects are achieved by this new and improved reusable dental articulator system. These objects and others that will become apparent hereinafter are attained, in accordance with the invention, in a dental articulator, which basically includes lower jaw member with male projection part to receive the disposable-mounting arm with female receiving aperture that holds a dental model of the mandibular portion of the jaw and upper jaw member with male projection part to receive the disposable-mounting arm with female receiving aperture that holds a dental model of the maxillary portion of the jaw. The dental articulator device is constructed from metal materials to provide enough hardness during use so that the accurate bite relationship can be repeatedly performed. The disposable-mounting arms are made from inexpensive plastic material that is economical in cost to manufacture. The disposable-mounting arms have different designs to accommodate different mediums used to mount the dental models in the disposable-mounting arms.

The disposable-mounting arm with an oval-shaped design is for the use of plaster of paris to mount the dental model on the disposable-mounting arm. The oval-shaped bar can receive the masses of plaster of paris that is used to affix the dental model to the disposable-mounting arm. The disposable-mounting arm with a ball-shaped design is to be used with the adhesive to mount the dental model on the disposable-mounting arm. The ball-shaped design provides a large range of angular and positional difference to allow the adhesive to attach the dental model to the disposable-mounting arm. The disposable-mounting arm whit a U-shaped tray design is for directly embedded the dental model to the tray while it still in unhardened stage and the dental model is formed right on the tray and subsequently attaches to the disposable-mounting arm.

This present invention has versatility that is not found in prior art articulators especially with respect to multiple methods to support the dental models. Dental models are able to secure to the disposable-mounting arms with the plaster of paris, an adhesive or a tray, which clip or slide onto the upper and lower jaw members of the articulator.

One primary advantage of present invention is that the dental laboratories can carry only this articulator system and still satisfy all different dentists' demand. The present invention is a reusable articulator but also has a disposable function. The dental models are removed from the articulator, when the technical work has been completed, by sliding them off together with the disposable-mounting arms. This procedure leaves the articulator clean and ready for reuse with another set of dental models. The present articulator system is versatile to provide multiple methods to support the dental models on the articulator, which can replace all the different articulators that the dental laboratories currently have to carry. Thus, it is going to save a lot of money and a lot of space for dental laboratories by using only one articulator system.

Another advantage of present invention is a user can easily remove a dental model from the dental articulator by applying a small separation force between the articulator and the model. The dental model can be repeatedly installed and removed from the dental articulator. Thus, during installation and removal of dental model from the dental articulator, a dental model will always realign and seat itself in exactly the same position each time it is reconnected and the proper alignment will be obtained each time.

Yet another advantage of present invention is consequently possible for the dentist to position the upper and lower models on his or her own articulator following return of the completed dental prosthesis from the laboratory to enable confirmation that the prosthesis is properly made.

It is still another advantage that the present invention can be used for various type of dental prosthesis elements, such as denture, crown, cap, laminate, bridge, inlay, onlay and the like.

It is yet another advantage that the present invention which the articulator is metal structure to have adequate stiffness to repeat the accurate bite relationship during use and the disposable-mounting arm is made of inexpensive plastic to allow disposal after use.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention. It is understood that change may be made in the form, size, proportions and minor details of construction without departing from the spirit of scarifying any of the advantage of the invention. The figures in the drawings are briefly described as follow:

FIG. 1 is a perspective view of a dental articulator with disposable-mounting arms.

FIG. 2 is a side view of the dental articulator.

FIG. 3 is a rear view of the dental articulator.

FIG. 4 is a top view of the dental articulator.

FIG. 5 is a bottom view of the dental articulator.

FIG. 6 is a perspective view of the oval-shaped disposable-mounting arm.

FIG. 7 is side view of the oval-shaped disposable-mounting arm.

FIG. 8 is top view of the oval-shaped disposable-mounting arm.

FIG. 9 is a perspective view of the U-shaped tray disposable-mounting arm.

FIG. 10 is side view of the U-shaped tray disposable-mounting arm.

FIG. 11 is top view of the U-shaped tray disposable-mounting arm.

FIG. 12 is a perspective view of the ball-shaped disposable-mounting arm.

FIG. 13 is side view of the ball-shaped disposable-mounting arm.

FIG. 14 is top view of the ball-shaped disposable-mounting arm.

FIG. 15 is side view of the dental articulator mounting dental models with ball-shaped disposable-mounting arm and U-shaped tray disposable-mounting arm.

FIG. 16 is perspective view of the dental articulator mounting dental models with oval-shaped disposable-mounting arms.

### DETAILED DESCRIPTION OF THE INVENTION

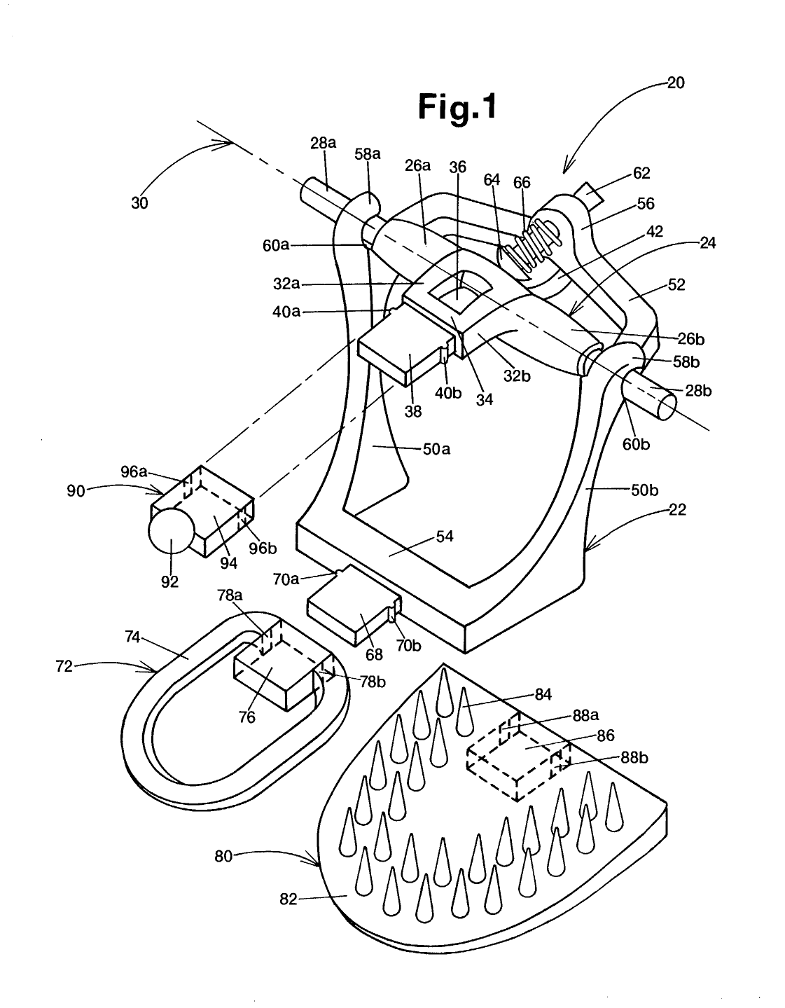

Referring now to the drawings, and in particular to FIG. 1, there is shown a dental articulator 20 according to the present invention for use in the fabrication and making of dental prosthesis with multiple methods to support the dental models by using different designs of the disposable-mounting arms 72, 80 and 90. The dental articulator 20 is constructed from metal such as chrome, brass, bronze or other similar suitable material. The disposable-mounting arms 72, 80 and 90 are formed from plastic or other suitable material.

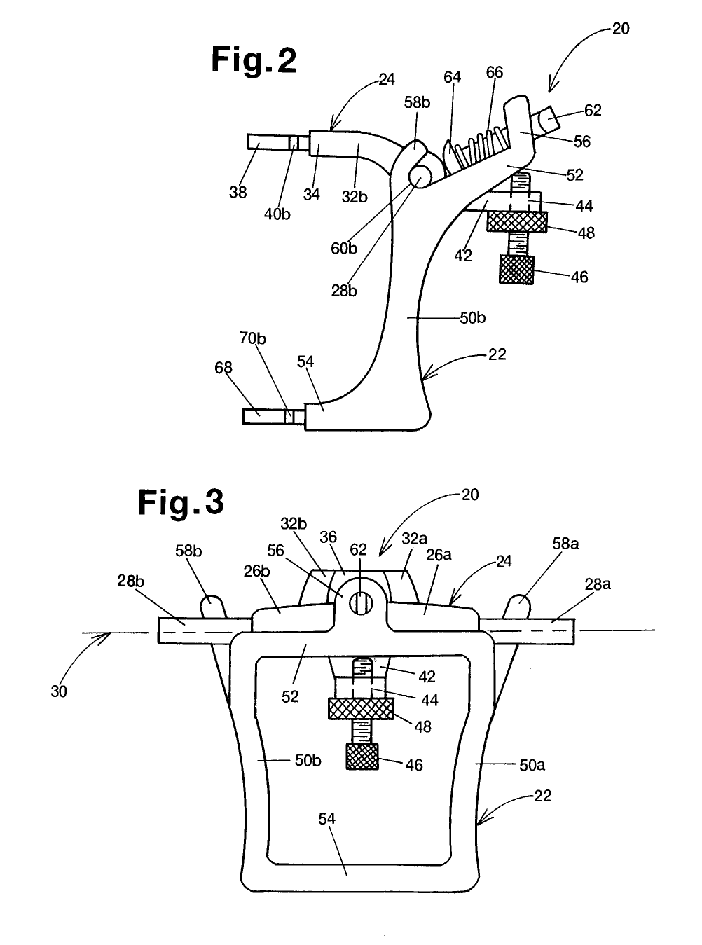

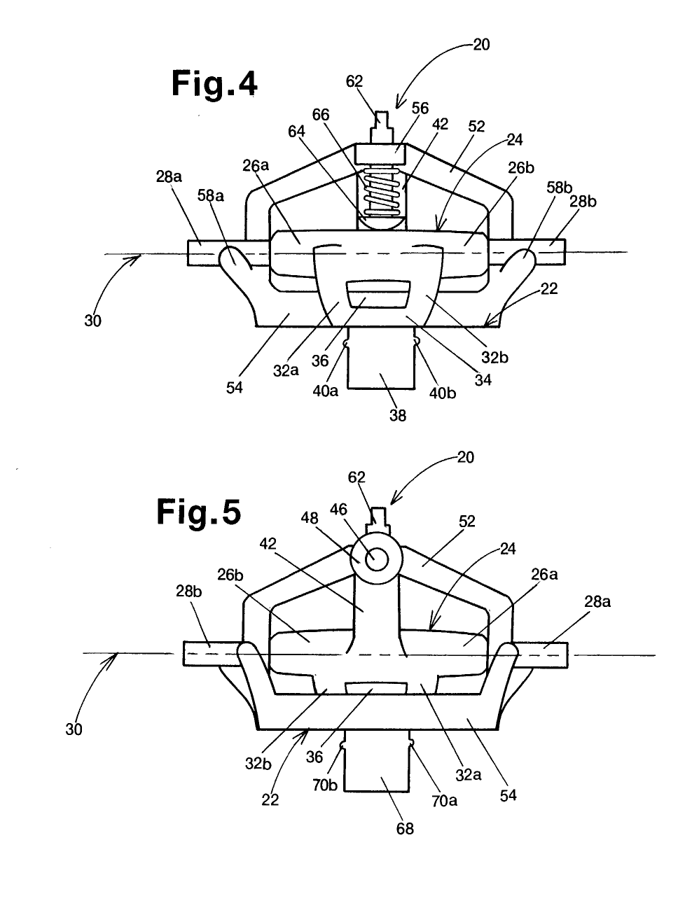

With reference to FIG. 1 through FIG. 5, the dental articulator 20 with a lower jaw member 22 pivotally mounts an upper jaw member 24. The upper jaw member 24 has outwardly extending bosses 26a, 26b with a pair of oppositely projecting coaxial beams 28a, 28b and a tail 42. The bosses 26a, 26b are apertured and aligned with arms 32a, 32b joined by a rib 34 creating a cut out portion 36. The rib 34 extent a rectangular male projection part 38 with two convex stops 40a, 40b on each side. The beams 28a, 28b define a common axis 30 extending transversely with respect to the upper jaw member 24. As seen in FIG. 2 and FIG. 3, the tail 42 has a threaded bore 44 for engaging and supporting a treaded bolt 46 and stop 48. In FIG. 2 shown the arm 32b, the rib 34 and the rectangular male projection part 38 are in the opposite side and parallel to the tail 42.

As seen in FIG. 1 through FIG. 5, the lower jaw member 22 has upwardly extending posts 50a, 50b joined by a bracket 52. The lower jaw member 22 also includes a pair of curved projection fingers 58a, 58b near the junctions between the posts 50a, 50b and the bracket 52. These curved fingers 58a, 58b define journals 60a, 60b for receiving and pivotally supporting the beams 28a, 28b of the upper jaw member 24. The journals 60a, 60b only partially surround the beams 28a, 28b so that the beams may be slid into and out of the journals to install or remove the upper jaw member 24 from engagement with the lower jaw member 22. The journals 60a, 60b open toward the bracket 52, and the upper jaw member 24 is held in pivotal engagement with the lower jaw member 22 by a spring-mounted pressure pin 62. The pressure pin 62, slidably disposed in an aperture formed through a boss 56 carried by bracket 52 is formed with a head 64 and so as to have a spring 66 wound about its shank and lodged between head 64 and boss 56. Spring 66, when so disposed, urges head 64 of pressure pin 62 against upper jaw member 24 to seat beams 28a, 28b thereof in journals 60a, 60b and maintain upper jaw member 24 in pivotal relationship with lower jaw member 22. On the bottom of the posts 50a, 50b joined by a base 54 extend a rectangular male projection part 68 with two convex stops 70a, 70b on each side.

As seen in FIG. 1 and FIG. 2, the upper jaw member 24 is formed to include a rectangular male projection part 38. In similar manner the lower jaw member 22 is formed to include a rectangular male projection part 68. The rectangular male projection parts 38, 68 both are of the same size and shape. As particularly seen in FIG. 2, when the lower jaw member 22 parallel with the upper jaw member 24, the male projection part 38 lines up with the male projection part 68.

As shown in FIG. 2, the tail 42 from upper jaw member 24 having a bolt 46 is threaded into an internally threaded bore 44 and is fitted with a stop 48. Adjustment of bolt 46 and its co-action with the underside of bracket 52 of lower jaw member 22, serves to adjust the position of upper jaw member 24 to lower jaw member 22.

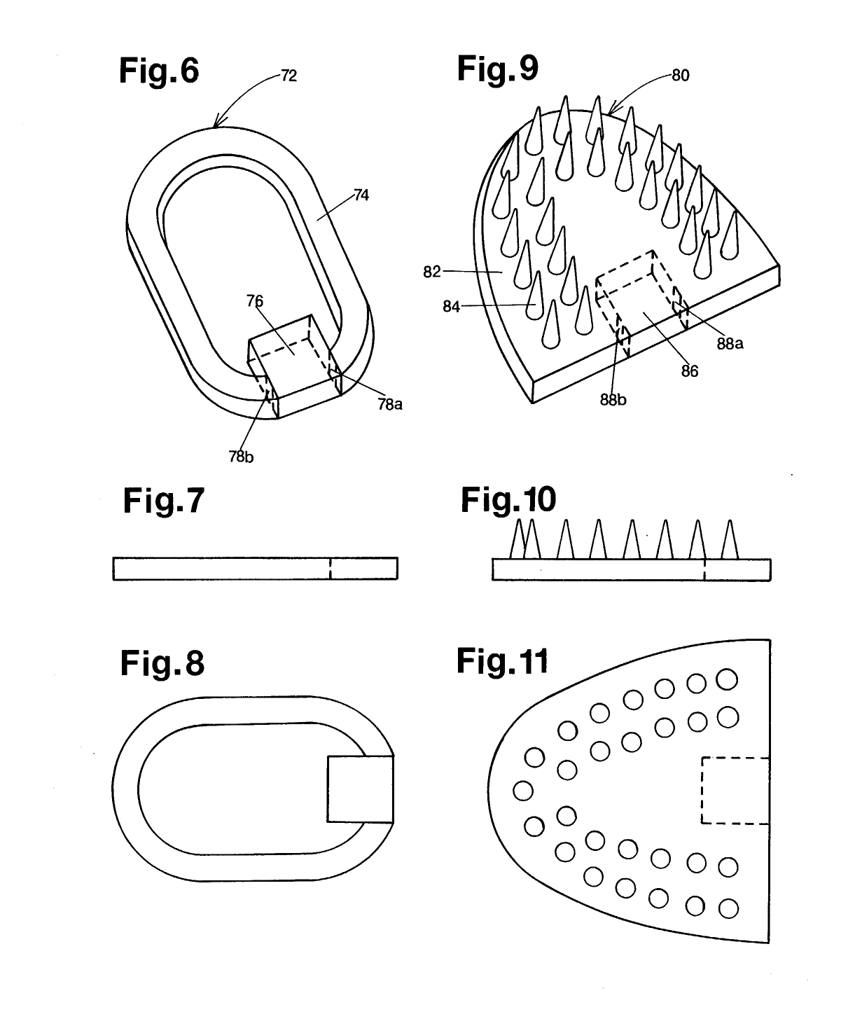

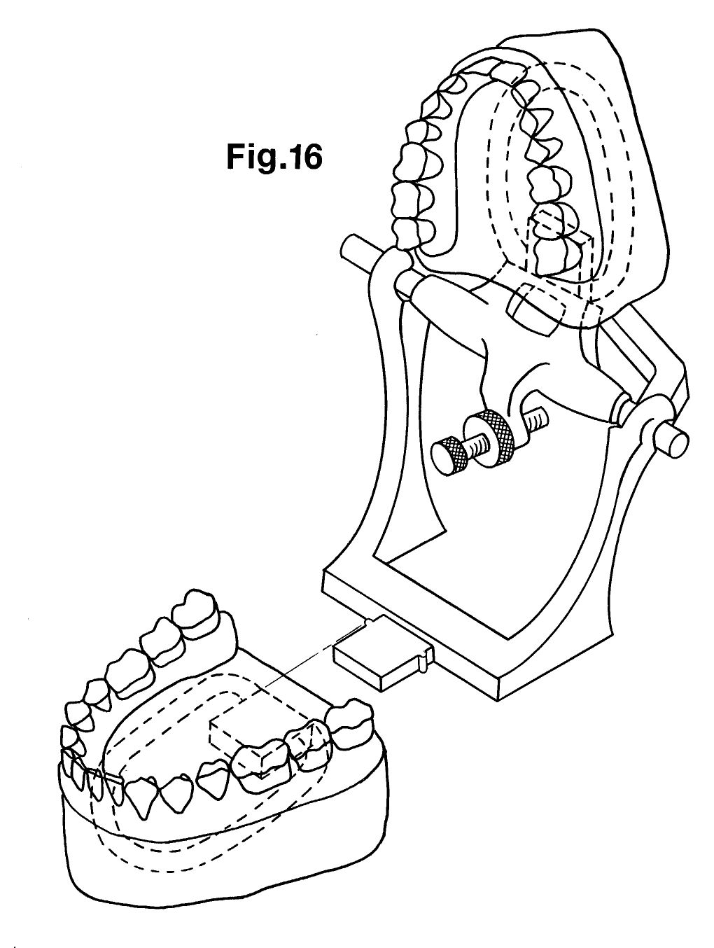

FIGS. 6 through 8 shows the perspective, side and top view of the oval-shaped design's disposable-mounting arm 72. The oval-shaped design's disposable-mounting arm 72 is formed to include an oval portion formed by peripheral bar 74 connected in a rectangular female receiving aperture 76 with two recesses 78a, 78b on both of the inside walls. The bar 74 is able to receive the masses of plaster of paris that are used to mount the dental model to the disposable-mounting arm 72 (see particularly FIG. 16). As seen in FIG. 1, the rectangular female aperture 76 is sized to releasable mount within either of the rectangular male projection parts 38, 68. The convex stops 40a, 40b on the rectangular male projection part 38 or the convex stops 70a, 70b on the rectangular male projection part 68 are mating with the recesses 78a, 78b so the rectangular female receiving aperture 76 is locked in position to either of the rectangular male projection parts 38, 68.

FIGS. 9 through 11 shows the perspective, side and top view of the U-shaped tray design's disposable-mounting arm 80. The U-shaped tray design's disposable-mounting arm 80 is formed to include a U-shaped tray 82 connected on the edge of a rectangular female receiving aperture 86 with two recesses 88a, 88b on both of the inside walls. On the top surface of the U-shaped tray 82 has a plurality of corn-shaped projections 84. The U-shaped tray 82 is for directly embedded the dental model into the tray 82 while dental model still in unhardened stage and then the dental model is formed right on the tray 82 and subsequently attaches to the disposable-mounting arm 80 (see particularly FIG. 15). As seen in FIG. 1, the rectangular female aperture 86 is sized to releasable mount within either of the rectangular male projection parts 38, 68. The convex stops 40a, 40b on the rectangular male projection part 38 or the convex stops 70a, 70b on the rectangular male projection part 68 are mating with the recesses 88a, 88b so the rectangular female receiving aperture 86 is locked in position to either of the rectangular male projection parts 38, 68.

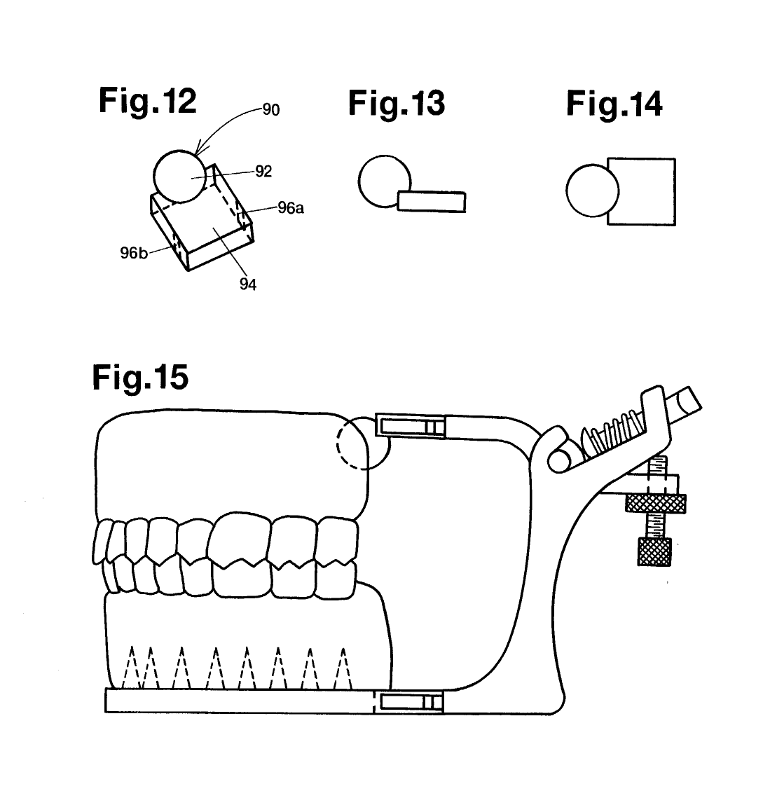

FIGS. 12 through 14 shows the perspective, side and top view of the ball-shaped design's disposable-mounting arm 90. The ball-shaped design's disposable-mounting arm 90 is formed to include a ball 92 joined by a rectangular female receiving aperture 94 with two recesses 96a, 96b on both of the inside walls. The ball 92 provides a large range of angular and positional difference to allow the adhesive to attach the dental model to the disposable-mounting arm 90 (see particularly FIG. 15). As seen in FIG. 1, the rectangular female aperture 94 is sized to releasable mount within either of the rectangular male projection parts 38, 68. The convex stops 40a, 40b on the rectangular male projection part 38 or the convex stops 70a, 70b on the rectangular male projection part 68 are mating with the recesses 96a, 96b so the rectangular female receiving aperture 94 is locked in position to either of the rectangular male projection parts 38, 68.

As seen in FIG. 1, the rectangular female receiving apertures 76, 86, 94 are identical in size, shape and function. The lower jaw member 22 and the upper jaw member 24 are designed to receive the disposable-mounting arms 72, 80, 90 by sliding the rectangular female receiving apertures 76, 86, 94 into the rectangular male projection parts 38, 68. Additionally, the plastic material of construction for the rectangular female receiving apertures 76, 86, 94 allow for certain elastic for recesses 78a, 78b, 88a, 88b, 96a, 96b to be snapped and locked into convex stops 40a, 40b, 70a, 70b of the rectangular male projection parts 38, 68. Consequently, each of the dental model mounting in the disposable-mounting arms 72, 80, 90 can always be positioned in exactly the same position on the lower jaw member 22 and the upper jaw member 24.

What I claim as my invention is:

1. A dental articulator apparatus for supporting dental models comprising:
a lower jaw means to receive and hold a model of the mandibular portion of the jaw;
an upper jaw means to receive and hold a model of the maxillary portion of the jaw;
an upper jaw pivotally mounted to said lower jaw;
a lower member having a male projection part carried by said lower jaw;
an upper member having a male projection part carried by said upper jaw;
wherein the male projection part in said lower and said upper members being of the same size and shape; and
a dental model disposable-mounting arm for each said upper and lower members being formed with a female receiving aperture and said female receiving aperture being sized to releasably mount within either of said male projection parts.

2. The dental articulator apparatus according to claim 1, wherein said lower jaw member includes a bracket and a boss fixed at the top thereof, and a spring-mounted pressure pin through said boss and a head abutting against said upper jaw member, a spring encircling said pressure pin between said head and said boss.

3. The dental articulator apparatus according to claim 1, wherein said lower jaw member includes a pair of spaced upwardly extending posts, each of said posts being split at the top thereof with said bracket fixedly secured thereto, said upper jaw member having beams resting in said spaced split portions and retained therein and pivotal thereabout.

4. The dental articulator apparatus according to claim 1, wherein said upper jaw member includes a tail with a bolt and a stop threadedly engaged with said bracket of said lower jaw member to control the inclination and alter the range of motion.

5. The dental articulator apparatus according to claim 1, comprising disposable-mounting arms with a female receiving apertures slidably and attachably received on each of said male projection parts carried by said upper and lower members and adapted for attachment to each of the upper and lower dental models.

6. The dental articulator apparatus according to claim 1, wherein each of said male projection parts carried by said upper and lower member include stops for receiving and securing each recesses wherein said female receiving apertures carried by said disposable-mounting arm in a defined perdetermined position, and position means repeatedly disconnections and reconnections on said disposable-mounting arms are always accurately located in a same unchanging position to each said upper and lower members.

7. The dental articulator apparatus according to claim 1, wherein said upper jaw member and said lower jaw member are made from metal, which is sufficiently rigid to create a reliable bite relationship without distortion.

8. The dental articulator apparatus according to claim 1, wherein said disposable-mounting arms are made from plastic, which has elastic for the recesses on said female receiving aperture to be removably mounted and locked in the stops for said male projection part of said upper and lower jaw members.

9. A disposable-mounting arm with an elliptical shape comprising an oval-shaped bar having an elliptical opening therethrough and connecting to said female receiving aperture, and said elliptical shape disposable mounting arm means oval-shaped bar receiving the masses of plaster of paris to attach the dental model to said disposable-mounting arm.

10. A disposable-mounting arm with a ball shape comprising a ball-shaped member connecting to said female receiving aperture, and said ball shape disposable-mounting arm means ball-shaped member providing a large range of angular and positional difference to allow adhesive to attach the dental model to said disposable-mounting arm.

11. A disposable-mounting arm with a horse shoe shape comprising a U-shaped tray having a plurality cone-shaped projections formed on the top surface of tray and connecting to said female receiving aperture, and said horse shoe shape disposable-mounting arm means U-shaped tray directly receiving the dental model right into the tray to attach the dental model to said disposable-mounting arm.
